(19) United States
(12) Patent Application Publication
(10) Pub. No.: US 2025/0149917 A1
(43) Pub. Date: May 8, 2025

(54) ENERGY MANAGEMENT SYSTEM FOR AN ELECTRICAL POWER GRID

(71) Applicant: Eaton Intelligent Power Limited, Dublin (IE)

(72) Inventors: Yi Liu, Lakewood, CO (US); Md Shakawat Hossan, Thornton, CO (US); Siddharth Suryanarayanan, Thornton, CO (US); Mohd Azrin Mohd Zulkefli, Thornton, CO (US); Arun Sukumaran Nair, Denver, CO (US)

(21) Appl. No.: 18/931,999

(22) Filed: Oct. 30, 2024

Related U.S. Application Data
(60) Provisional application No. 63/596,000, filed on Nov. 3, 2023.

(51) Int. Cl. H02J 13/00; H02J 3/00

(52) U.S. Cl. CPC H02J 13/00006; H02J 3/003; H02J 3/004

(57) ABSTRACT

A system includes: a central controller configured to generate an energy management request; and one or more client controllers. Each of the one or more client controllers is configured to communicate with the central controller through a first communications network, each of the one or more client controllers is associated with a controllable service location, and each of the one or more client controllers is configured to communicate with a premises energy management system (PEMS) that commands one or more controllable energy resources at the controllable service location to operate according to a user specification and the energy management request.

### CROSS-REFERENCE TO RELATED APPLICATION

This application claims the benefit of U.S. Provisional Application No. 63/596,000, filed on Nov. 3, 2023 and titled ENERGY MANAGEMENT SYSTEM FOR AN ELECTRICAL POWER GRID, which is incorporated herein by reference in its entirety.

### STATEMENT OF FEDERALLY FUNDED RESEARCH

This invention was made with government support under Government Contract DE-EE009023 awarded by the United States Department of Energy. The government has certain rights in the invention.

### TECHNICAL FIELD

This disclosure relates to an energy management system for an electrical power grid.

### BACKGROUND

An electrical power grid includes one or more sources of electricity, one or more loads, and mechanisms for distributing electrical power from the sources to the loads. The flow of electricity on the electrical grid may be disturbed by planned maintenance, unexpected equipment failure, electrical faults, and extreme weather.

### SUMMARY

In one aspect, a system includes: a central controller configured to generate an energy management request; and one or more client controllers. Each of the one or more client controllers is configured to communicate with the central controller through a first communications network, each of the one or more client controllers is associated with a controllable service location, and each of the one or more client controllers is configured to communicate with a premises energy management system (PEMS) that commands one or more controllable energy resources at the controllable service location to operate according to a user specification and the energy management request.

Implementations may include one or more of the following features.

The central controller may generate the energy management request based on information from the PEMS. The information may include one or more of a forecasted energy consumption of the one or more controllable energy resources, a forecasted energy production of the one or more controllable energy resources, a net controllable load at the controllable service location, thermal characteristics of the controllable service location, and a net load at the controllable service location.

The central controller may generate the energy management request based on forecasted whether information.

The central controller may generate the energy management request based on input from a grid operating entity.

The central controller may generate the energy management request based on a pre-determined temporal schedule.

The first communications network may include a radio-frequency (RF) mesh network, and each client controller may communicate with the respective PEMS using a two-way communications protocol. The central controller may communicate with a headend that communicates with the first communications network. The central controller may communicate with the headend via a hypertext transfer protocol (HTTP), and each client controller communicates with the respective PEMS via HTTP. The headend may include a demand response management system (DRMS), an advanced distribution management system (ADMS), or a DER management system (DERMS).

Each client controller may communicate with one or more of a metering system, a breaker, and a load sensor.

In another aspect, a premises energy management system includes: a communications module configured to communicate with a controllable energy resource; a preference module configured to store a specification that defines one or more acceptable operating bounds for the controllable energy resource; and a scheduling module configured to determine an operating plan for the controllable energy resource, the scheduling module including an idle operating mode and a grid-event operating mode. In the idle operating mode, the scheduling module is configured to determine the operating plan based on price information and the one or more acceptable operating bounds; and, in the grid-event operating mode, the scheduling module is configured to determine the operating plan based on the one or more acceptable operating bounds and a demand request.

Implementations may include one or more of the following features.

The premises energy management system of also may include a command module configured to provide a command signal to the controllable energy resource based on the operating plan.

The premises energy management system also may include a climate module configured to receive climate information, and the scheduling module may be configured to determine the operating plan based on the climate information.

The communications interface is configured to communicate with the controllable energy resource using the IEEE 2030.5 protocol, and the communications interface may be further configured to communicate with a local controller. The communications interface may be configured to communicate with the local client controller using Transmission Control Protocol/Internet Protocol (TCP/IP) or User Datagram Protocol (UDP).

The premises energy management system also may include an input/output module, and the specification may be configured to be edited through the input/output module.

In another aspect, a method for managing energy usage in a power grid, the method includes: receiving information generated by a plurality of premises energy management systems, each premises energy management system (PEMS) being associated with a distinct controlled service location; receiving a grid event trigger; determining an energy management request based on the information from the plurality of PEMS; and managing energy usage in the power grid by providing the energy management request to one or more recipient PEMS. Each of the one or more recipient PEMS is associated with one distinct controlled service location.

Implementations may include one or more of the following features.

Information related to one or more distinct uncontrolled service locations that are not associated with a premises energy management system may be accessed; and the energy management request may be based on the information related to the one or more distinct uncontrolled service locations and the information from the plurality of PEMS.

The information from the plurality of PEMS may include one or more of a controllable energy resource consumption range, a net controllable load, a net load, distributed energy resource (DER) nameplate information, service location thermal parameters, DER state information, and weather information.

Implementations of any of the techniques described herein may include a system, a controller, a control system, a premises energy management system (PEMS) or a method. The details of one or more implementations are set forth in the accompanying drawings and the description below. Other features will be apparent from the description and drawings, and from the claims.

### DRAWING DESCRIPTION

FIG. 1A is a block diagram of an energy management system.

FIG. 1B is a block diagram of an electrical power grid.

FIG. 2 is a block diagram of a premises energy management system (PEMS).

FIG. 3 is a block diagram of a central controller.

FIG. 4 is an example of an end-to-end (E2E) communication architecture.

FIG. 5 is a flow chart of a process for managing behind-the-meter energy resources.

FIG. 6 is a flow chart of a process for managing energy on a power grid.

### DETAILED DESCRIPTION

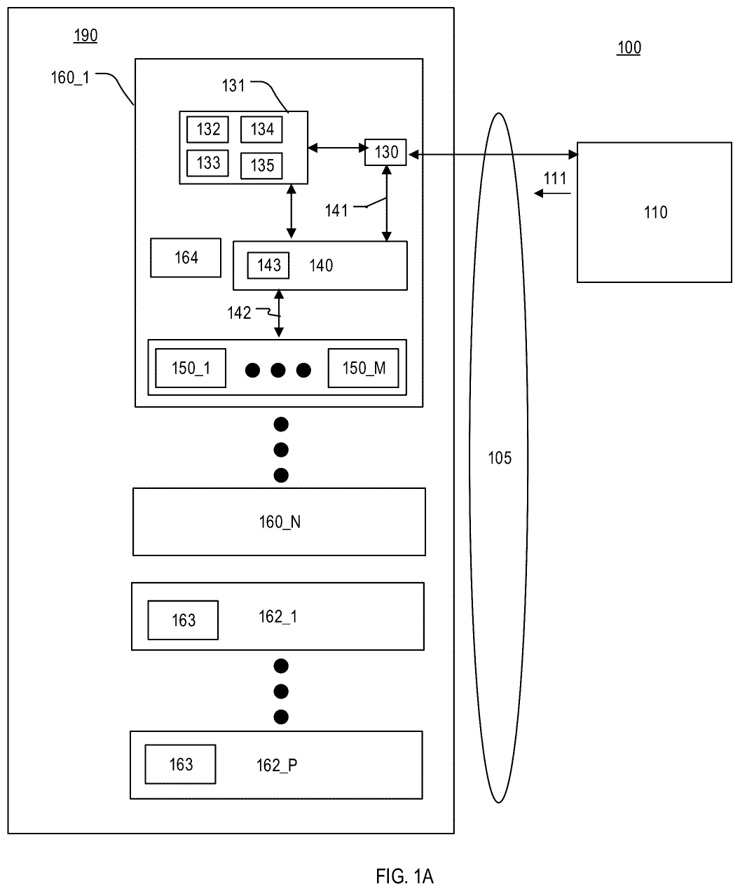

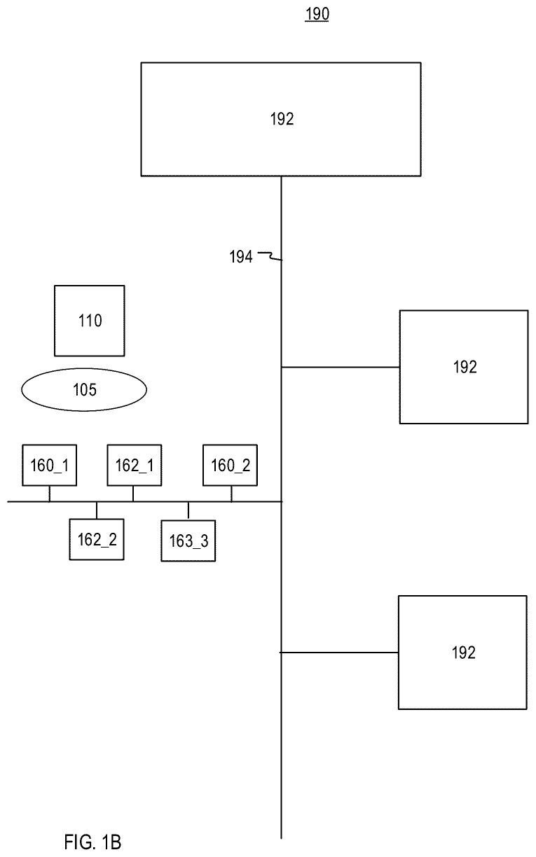

FIG. 1A is a block diagram of an energy management system 100 for an electrical power grid 190. The electrical power grid 190 is operated, managed, and/or owned partially or completely by a grid operating entity. The grid operating entity may be, for example, an electrical utility, a grid operator, or electrical power service provider. The electrical power grid 190 includes controllable service locations 160_1 to 160_N (collectively the locations 160) and may also include uncontrolled service locations 162_1 to 162_P (collectively the locations 162), where N and P are integer numbers equal to or greater than 1.

Referring also to FIG. 1B, the electrical power grid 190 includes one or more electrical energy sources 192 and a distribution network 194 (for example, distribution lines, cables, electrical wires, transformers, and structures to support the network) that distributes electrical energy between the sources 192 and various loads, including the controllable service locations 160 and the uncontrolled service locations 162.

Each controllable service location 160 and uncontrolled service location 162 is a premises, site, or location that receives electrical energy from the electrical power grid 190 and may also provide electrical energy to the electrical power grid 190. A customer of the grid operating entity may be associated with one or more premises. The premises may be a residential location or residential asset. Specific examples of premises include, without limitation, single-family dwellings; office buildings; co-working spaces; storage facilities; townhouses; and individual apartment, condominium, office, or trailer units within a larger community made up of similar units. Moreover, a premises is not necessarily an enclosed space and may be entirely or partially outdoors.

The energy management system 100 is a hierarchical communication and control architecture that uses existing advanced metering infrastructure (AMI) to manage and control electrical behind-the-meter (BTM) controllable energy resources 150_1 to 150_M (collectively the BTM energy resources 150) at the controllable service locations 160_1 to 160_N. The BTM energy resources 150 are any type of energy producing and/or consuming device that has a controllable output. The BTM energy resources 150 may include controllable appliances and/or distributed energy resources (DERs). Controllable appliances are appliances that have a variable and controllable output that may depend on customer behavior and/or environmental factors. Examples of controllable appliances include, for example, electric water heaters; inverters; and electric heating, air conditioning, and ventilation (HVAC) systems. A DER is any source of electricity that is capable of providing localized power. Photovoltaic (PV) systems, batteries, wind turbines and windmills, and electric vehicles (EVs) with bi-directional capabilities are examples of DERs. The amount of energy generated by a DER is generally less than a traditional, centralized power source. For example, a DER may generate 1 kiloWatt (kW) to 10,000 kW of electricity.

The energy management system 100 is an architecture that considers bi-directional end-to-end (E2E) information exchange between the controllable service locations 160_1 to 160_N and the central controller 110 for visibility, coordination, and controllability and is capable of enabling different grid services and economic load control. Furthermore, the energy management system 100 also accounts for the presence of uncontrolled service locations 162_1 to 162_P in configurations that include uncontrolled service locations.

The energy management system 100 includes a central controller 110 that is associated with the grid operating entity. Each controllable service location 160_1 to 160_N includes a local controller 130 that communicates with the central controller 110, and a premises energy management system (PEMS) 140 that communicates with the local controller 130 and with the BTM energy resources 150_1 to 150_M. The PEMS 140 and the local controller 130 may be part of one network-enabled device and may be different programs that run within that one network-enabled device. A network-enabled device is a device that is capable of communicating with other network-enabled devices on an electromagnetic or electronic communications network, such as the Internet. Moreover, although the PEMS 140 and the local controller 130 are discussed as separate items, the functionality of the local controller 130 may be implemented in the PEMS 140 such that the PEMS 140 acts as the local controller 130. In other words, in some implementations, the PEMS 140 communicates with the central controller 110 and the BTM energy resources 150, and the controllable service locations 160_1 to 160_N may lack a separate local controller 130.

To manage the flow of electricity in the electrical grid 190 during a grid event or in anticipation of a grid event, the central controller 110 may generate a demand response signal 111. The demand response signal 111 also may be referred to as an energy management request 111. A grid event is any occurrence that affects the power flow in the grid 190. Examples of grid events include, for example, storms, heat waves, extreme cold, widespread equipment failure or malfunction, and planned maintenance.

The central controller 110 provides the demand response signal 111 to all or some of the controllable service locations 160_1 to 160_N, and the local controllers 130 that receive the demand response signal 111 provide it to the respective PEMS 140. The PEMS 140 controls the BTM energy resources 150_1 to 150_M in accordance with an operating preference 143 and the demand response signal 111 to thereby manage the electricity in the electrical power grid 190 in accordance with the grid operating entities request and the operating preference 143.

The PEMS 140 also manages the BTM energy resources 150_1 to 150_M in the absence of the demand response signal 111. For example, the PEMS 140 may manage the BTM energy resources 150_1 to 150_M in a manner that achieves the lowest energy cost for the customer while also meeting the operating preference 143.

The popularity of BTM DERs and controllable appliances is growing and the variable nature of these loads may present challenges to the operation of the electrical grid 190. For example, the electrical output of some BTM DERs, such as PV systems and wind-based systems, depends on weather and/or the diurnal cycle. Other BTM controllable appliances depend on human behavior that varies in predicable and unpredictable ways. Furthermore, extreme weather and other effects of climate change also increase the stress on the electrical grid 190.

The energy management system 100 provides the central controller 110 with visibility into and control over the operation of the BTM energy resources 150 at each controllable service location 160_1 to 160_N. This visibility allows the energy management system 100 to coordinate the BTM energy resources 150_1 to 150_M within an individual controllable service location as well as with BTM energy resources 150 in the other controllable service locations. This coordination improves the predictability of electrical service throughout the grid 190 and also increases efficiency such that electrical energy may be reliably and economically delivered to more customers.

An overview of the controllable service location 160_1 is discussed next. Each controllable service location 160_1 to 160_N may be configured in a manner similar to the controllable service location 160_1, and, for simplicity, only the controllable service location 160_1 is discussed in detail.

The controllable service location 160_1 includes the local controller 130. Like the central controller 110, the local controller 130 is associated with the grid operating entity. For example, the local controller 130 may be installed and/or owned by the grid operating entity. The local controller 130 is any type of electronic system that is capable of sending data to and receiving data from the central controller 110. For example, the local controller 130 may be a gateway or a client in a client/server scheme. The local controller 130 may be hosted on a workstation, such as a computer, laptop, router, or smartphone, or the local controller 130 may be integrated into another component at the controllable service location 160_1. The local controller 130 and the PEMS 140 may be implemented in the same network-enabled device.

The local controller 130 communicates with the central controller 110 via a communications network 105. The communications network 105 is any type of communications network that allows two-way or bi-directional communication of data and signals between remote devices. For example, the communications network 105 may be a radio frequency (RF) communications network. The local controller 130 also communicates with the PEMS 140 via a local communications link or network 141. The PEMS 140 and the local controller 130 are at the controllable service location 160_1. The central controller 110 is remote from the controllable service location 160_1. The central controller 110 is also remote from the other controllable service locations 160_2 to 160_N and the uncontrolled service locations (collectively 162).

The local-network communication 141 is distinct from the communications network 105. Any type of communication network or link capable of two-way information exchange between different programs executed within the same network-enabled device may be used as the local-network communications link 141. For example, the local communications link 141 may use Transmission Control Protocol/Internet Protocol (TCP/IP), User Datagram Protocol (UDP), or hyper-text transfer protocol (HTTP) on a local internet-based link (for example, IEEE 802.11 (WiFi) or IEEE 802.3 (Ethernet)).

The controllable service location 160_1 is also associated with a metering device 131 that includes a communications interface 132, an electronic processing module 133, and an electronic storage 134. The communications interface 132 allows the metering device 131 to communicate with the local controller 130, the PEMS 140, and/or the central controller 110. The metering device 131 measures data related to the amount of electricity consumed and/or produced at the controllable service location 160_1. For example, the metering device 131 may include current and/or voltage sensors and associated components. The measured data is stored on the electronic storage 134 as site metering data 135. The site metering data 135 may be net-metered information.

The metering device 131 may be, for example, a smart meter that is part of an advanced metering infrastructure (AMI). A smart meter may record consumption at the controllable service location 160_1 at least hourly and transmits the measurements to the local controller 130 and/or the central controller 110 at least daily. In some implementations, the local controller 130 and/or the PEMS 140 are implemented as part of the metering device 131. Other examples of the metering device 131 include a metering system, a breaker, and a load sensor.

The PEMS 140 communicates with and controls the BTM energy resources 150_1 to 150_M at the controllable service location 160_1 via a control link 142. The energy resources 150 are behind-the-meter (BTM) because the local controller 130 (or the PEMS 140 when the PEMS 140 is also the local controller) is between the central controller 110 and the BTM energy resources 150. The control link 142 uses a communications protocol that supports two-way communication such as, for example, Modbus, DNP (Distributed Network Protocol for Supervisory Control and Data Acquisition (SCADA) networks), or IEEE 2030.5.

The controllable service location 160_1 also may include other electrical resources that have an output that is not controllable or an output that should be maintained regardless of power disruptions in the grid 190. These electrical resources are referred to as uncontrolled loads 164. Examples of uncontrolled loads 164 include, for example, lighting systems, critical electrical equipment (such as medical equipment and computing resources), and food storage systems.

As noted above, the central controller 110 may issue the demand response signal 111 to the local controller 130 in some or all of the controllable service locations 160_1 to 160_N to manage electricity use in the grid 190. In response to receiving the demand response signal 111, the PEMS 140 uses the discerned or known amount of electricity consumed and/or generated by the BTM electrical resources 150 and the uncontrolled loads 164 to coordinate and schedule future operations of the BTM electrical resource 150 while maintaining the output of the BTM energy resources 150 to a level that meets the operating preferences 143. In this way, the grid operating entity is able to control the BTM energy resources 150 at the controllable service locations 160_1 to 160_N to manage the electricity in the electrical grid 190 while maintaining customer satisfaction. The other controllable service locations 160_2 to 160_N are configured in a manner similar to the controllable service location 160_1. The central controller 110 is also able to control the BTM energy resources at the controllable service locations 160_2 to 160_N with the demand response signal 11.

Each uncontrolled service location 162_1 to 162_P includes a metering device 163 that is installed by the grid operating entity. For example, the metering device 163 may be a traditional metering device that measures electricity consumption but is read based on visual inspection at the metering device 163 instead of by communicating the measured data to the central controller 110. The uncontrolled service locations 162_1 to 162_P do not include the PEMS 140 or the local controller 130. The uncontrolled service locations 162_1 to 162_P may or may not include controllable appliances and DERs and the uncontrolled service locations 162_1 to 162_P do not receive the demand response signal 111 or communicate with the central controller 110. However, the central controller 110 accounts for the presence of the uncontrolled service locations 162_1 to 162_P.

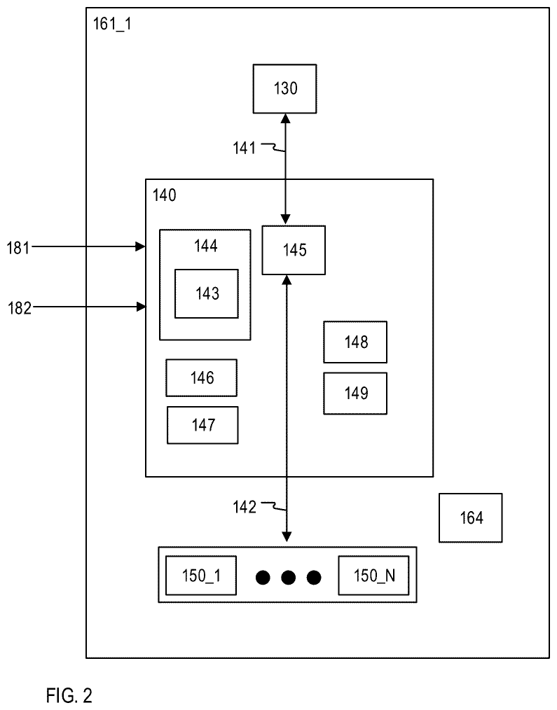

FIG. 2 is a more detailed block diagram of the PEMS 140. FIG. 2 shows the PEMS 140 in the controllable service location 160_1.

The PEMS 140 includes an electronic storage 144, a communications interface 145, an electronic processing module 148, and an input/output interface 149. The communications interface 145 is any interface that allows the PEMS 140 to communicate with the local controller 130 via the local network 141 and with the BTM energy resources 150 via the control link 142. For example, in implementations in which the local network 141 is based on TCP/IP, the interface 145 may include a local TCP socket to facilitate sending and receiving messages.

The electronic processing module 148 includes one or more electronic processors. The electronic processors of the module 148 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 144 is any type of electronic memory that is capable of storing data, and the electronic storage 144 may include volatile and/or non-volatile components. The electronic storage 144 and the processing module 148 are coupled such that the processing module 148 can access or read data from the electronic storage 144 and can write data to the electronic storage 144.

The electronic storage 144 stores the operating preferences 143. The operating preferences 143 are threshold values, ranges of values, and/or other information that specify a minimum operating standard for the BTM energy resources 150. For example, the preferences 143 may set a lower temperature bound and an upper temperature bound for a cooling mode of an HVAC system. In this example, the preferences 143 specify that the HVAC should not output cool air when a thermostat associated with the HVAC measures a temperature below the lower temperature bounds and should output cool air when the thermostat measures a temperature above the upper temperature bound.

The preferences 143 may include additional information. For example, the preferences 143 may have different upper and lower temperature bounds for different times of the day and/or for different times of the week. In another example, the preferences 143 may include a range of values that correspond to hourly electricity price that the customer associated with the controllable service location 160_1 has subscribed to with the utility provider.

The electronic storage 144 also includes data and information related to the BTM energy resources 150 and the controllable service location 160_1. For example, the electronic storage 144 may store historical load profiles of the uncontrollable loads 164, historical load profiles of the BTM energy resources 150, nameplate information for the BTM energy resources 150, and/or nameplate information for the uncontrollable loads 164. The nameplate information may include, for example, capacity for energy output in kilowatts (kW), efficiency, and/or power rating which can be requested from certain IEEE 2030.5 enabled end-devices 150 via communication link 142. The electronic storage 144 also includes calibrated properties specific for the controllable service location 160_1 such as, for example, thermal properties of the controllable service location 160_1.

The PEMS 140 also includes a scheduling module 146 and a command module 147. The modules 146 and 147 are stored on the electronic storage 144 as, for example, machine-readable instructions, a computer program, or software that can be executed by the processing module 148. The scheduling module 146 determines an operating plan for the BTM energy resources 150. The operating plan specifies a target output for the BTM energy resources 150 over a temporal time period.

The command module 147 controls the time-based executions of the different functions in 140. Frist, the command module 147 operates the BTM energy resources 150 based on the operating plan. For example, the command module 147 may generate a command signal that causes one of the BTM energy resources 150 to operate at a certain capacity for a defined amount of time based on the operating plan. The command signal may operate the BTM energy resources 150 in any manner and is not limited to turning the BTM energy resources on and off, although the command signal may turn one or more of the BTM energy resources 150 on or off based on the operating plan. Secondly, the command module 147 facilitates the executions of the communication interface 145 by controlling the timings and frequencies of messages-checking, message-requesting and message-sending with BTM energy resources 150, local controller 130, and electronic storage 144. For example, some communications involve longer (for example, an hour or more) data exchanges while others involve more frequent (for example, 10 to 15 minutes) data exchanges. Finally, the command module 147 also facilitates the executions of the scheduling module 146. For example, since module 146 may utilize a computational-intensive optimization routine to prepare a day-ahead operating plan for BTM energy resources 150, the module 147 may command module 146 ahead of time to ensure the operating plan is ready before the scheduled start time.

The electronic storage 144 also may include additional modules. For example, the electronic storage 144 stores instructions that, when executed by the electronic processing module 148, perform a disaggregation technique on the site metering data 135 to separate the net load information in the site metering data 135 into individual load for the BTM energy resources 150 and the uncontrollable loads 164. Any known disaggregation technique may be used. Moreover, the disaggregated load information may be stored on the electronic storage 144 and used for determining the operating plan by the scheduling module 146.

In another example, the electronic storage 144 may include a climate module that is configured to receive forecasted and/or actual weather or climate information 181. The climate information 181 may include measured data from a weather station or climate sensor at the controllable service location 160_1. For example, the climate information 181 may include indoor air temperature, outdoor air temperature, or indoor or outdoor humidity. The climate information 181 may be forecasted weather information available from a weather service. For example, the climate information 181 may be the forecasted outdoor air temperature for the next day or week, forecasted cloud cover over the next day, and/or sunrise and sunset time. In these implementations, the scheduling module 146 may use the climate information 181 when determining the operating plan.

In another example, the electronic storage 144 also may store pricing information 182. The pricing information 182 may be from the central controller 110 or from a separate pricing entity. The pricing information 182 may include, for example, current energy prices and forecasted energy prices, or a pseudo pricing signal for load reduction. In these implementations, the scheduling module 146 may use the pricing information 182 to determine the operating plan.

The I/O interface 149 is any interface that allows a human operator and/or an autonomous process to interact with the PEMS 140. The I/O interface 149 also allows the PEMS 140 to receive data and signals from sources other than the local controller 130 and the BTM energy resources 150. For example, the I/O interface 149 may be an interface that connects to a weather station or a database that includes pricing information. The I/O interface 149 may include, for example, a display, a keyboard, audio input and/or output (such as speakers and/or a microphone), a serial or parallel port, a Universal Serial Bus (USB) connection, and/or any type of network interface, such as, for example, Ethernet. The I/O interface 149 also may allow communication without physical contact through, for example, an IEEE 802.11, Bluetooth, or a near-field communication (NFC) connection.

The I/O interface 149 also may allow PEMS 140 to communicate with systems external to and remote from the system 100 such as, for example, a computer-based work station, a smart phone, tablet, or a laptop computer that connects to the PEMS 140 via a services protocol or a radio-frequency signal. The end-user (for example, a customer associated with the controllable service location 160_1) or the grid operating entity may change and edit the preferences 143 through the I/O interface 149.

The PEMS 140 ensures that the BTM energy resources 150 are operated in a manner that meets the preferences 143 while also responding to any grid service request signals from the grid operating entity (such as the demand response signal 111). The demand response signal 111 is typically infrequent and is issued when the electrical grid 190 is stressed due to, for example, impending imbalances between available generation and demand such as during extreme heatwaves or hurricanes. To promote efficiency, the PEMS 140 may be configured with two operating modes: an idle mode and a grid-event mode.

The idle mode is the default mode for the PEMS 140. The idle mode is active when there is no grid event, and the scheduling module 146 determines the operating plan without consideration of the demand response signal 111. In the idle mode, the operating plan can be determined using the pricing information 182. For example, the scheduling module 146 may determine the operating plan that results in the lowest cost over a set time period (for example, 24 hours, 2 days, or 1 week) by scheduling the operation of some or all of the BTM energy resources 150 for times of the day when the price of electricity is lowest. The scheduling module 146 may use information other than the pricing information 182 to determine the operating plan. For example, the climate information 181 and/or information about the uncontrolled loads 164 also may be used to determine the operating plan. For example, the scheduling module 146 may include a price optimization routine that minimizes the electricity cost while maintaining operation at the level indicated in the preferences 143 by forecasting the demand of the uncontrolled loads 164 and scheduling all or some of the BTM energy resources 150 to operate only at the times of the day that have or are forecasted to have low energy prices.

In the grid event mode, a demand response signal 111 is received, and the PEMS 140 determines the operating plan so that the BTM energy resources 150 are operated in accordance with the demand response signal 111 and the preferences 143 during the grid event. The demand response signal 111 specifies the duration of the grid event and indicates a grid event threshold for the duration of the grid event. For example, the duration of the grid event may be several hours (for example, 2 or 3 hours), and the grid event threshold may be the maximum total power the controllable service location 160_1 is allocated for the duration of the grid event.

The demand response signal 111 may also be associated with a timing signal and a price signal that are broadcast by the central controller 110 prior to the grid event beginning. The timing signal indicates a start and end time for the grid event, and the price signal indicates the price of electricity during the grid event. The PEMS 140 translates the pricing signal into the net premises load threshold, based on the premises historical loads behavior, to determine the operating plan. The net premises load threshold represents the upper and lower load margins for the BTM energy resources 150 to maintain the preferences 143 for the controllable service location 160_1 during the grid event. The PEMS 140 also calculates the flexibility and availability of the BTM energy resources 150 and sends the information to the central controller 110 via the local controller 130.

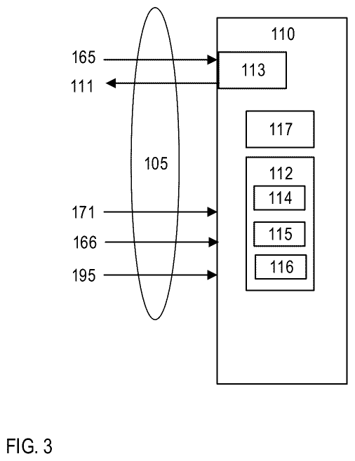

FIG. 3 is a more detailed block diagram of the central controller 110. The central controller 110 includes an electronic processing module 117, an electronic storage 112, and a communications interface 113. The electronic processing module 117 includes one or more electronic processors. The electronic processors of the module 117 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 112 is any type of electronic memory that is capable of storing data, and the electronic storage 112 may include volatile and/or non-volatile components. The electronic storage 112 and the processing module 117 are coupled such that the processing module 117 can access or read data from the electronic storage 112 and can write data to the electronic storage 112.

The communications interface 113 is any device that allows the central controller 110 to send data and receive data over the communications network 105. For example, in implementations in which the communications network 105 is an RF network, the communications interface 113 may be an RF transceiver. The central controller 110 receives data 165 from the controllable service locations 160_1 to 160_N via the communications network 105.

The central controller 110 also may receive grid information 195, weather information 171, and uncontrolled premises information 166 via the communications network 105 or by the grid operating entity entering the information into the central controller 110. The grid information 195 includes any type of information about the grid 190 and/or the components of the grid 190. For example, the grid information 195 may include information about power generation from an energy source 192. The weather information 171 includes weather forecast data for one or more locations in the grid 190. The weather information 171 may be transmitted to the central controller 110 from one or more weather stations or from a weather forecasting service. Additionally, some or all of the weather information 171 may be included in the data 165 from the controllable service locations 160_1 to 160_N. The uncontrolled premises information 166 includes information about the amount of energy consumed by the uncontrolled service locations 162_1 to 162_N. The uncontrolled premises information 166 may be entered into the central controller 110 by the grid operating entity or transmitted to the central controller 110 through the communications network 105 by a technician.

To initiate a grid event, the central controller 110 also provides the demand response signal 111 to some or all of the controllable service locations 160_1 to 160_N via the communications network 105. The grid event may be a planned grid event or an unplanned grid event. A planned grid event is a disruption of the power flow or a decrease in available energy in the grid 190 due to a known or expected event. A planned grid event may be, for example, scheduled maintenance or a scheduled reduction of energy cost or total energy expenditure ahead of an expected weather event. An unplanned grid event is caused by an unexpected event, such as extreme weather or equipment failure that causes the energy consumption in the grid 190 to peak unexpectedly.

The electronic storage 112 stores information related to the grid 190, the controllable service locations 160_1 to 160_N, and the uncontrolled service locations 162_1 to 162_N. For example, the electronic storage 112 may store historical load profiles and average energy consumption data for the uncontrolled service locations 162_1 to 162_N. In another example, the electronic storage 112 may store information about the sources 192 that are included in the electrical grid 190. For example, the electronic storage 112 may store average energy output for each of the sources 192.

The electronic storage 112 also stores machine-executable instructions in the form of, for example, software, subroutines, or functions. The instructions include instructions to implement a command module 114, a forecasting module 115, a data aggregating module 116. The data aggregation module 116 aggregates the data 165 received from all of the controllable service locations 160_1 to 160_N, the grid information 195, the weather information 172, and the uncontrolled premises information 166 and provides the aggregated data to the forecasting module 115. The forecasting module 115 forecasts the total uncontrolled load on the grid 190 based on the aggregated data. The forecasted total uncontrolled load includes the forecasted energy consumption of the uncontrolled loads 164 in the controllable service locations 160_1 to 160_N as well as the forecasted energy consumption of the uncontrolled service locations 162_1 to 162_P.

The command module 114 generates the demand response signal 111. The demand response signal 111 specifies a grid event duration and a grid event threshold. The grid event threshold is based on the forecasted total uncontrolled load during the grid event and the available controllable BTM energy resources at the controllable service locations 160_1 to 160_N. The grid event duration is the temporal duration of the grid event. The grid event threshold relates to the amount of energy that a controllable service location can consume during the grid event duration. The grid event threshold may be expressed as a maximum total energy consumption allowed during the grid event, a maximum energy consumption allowed at any time during the grid event, or a specified reduction in energy consumption compared to an average energy consumption. The demand response signal 111 also may include a grid event start time and a price signal. The grid event start time is the time at which the grid event is scheduled to begin. The price signal is an indication of the price of electricity over the grid event. The price signal may include different prices for different times during the grid event.

As noted above, the grid event may be a planned grid event or an unplanned grid event. For a planned grid event, the command module 114 sets the start time for the demand response signal 111 to be in the future, for example, for the next day or for a time that is shortly before the planned grid event. The start time may be set to a time that reduces energy costs and/or reduces greenhouse gasses.

For an unplanned grid event, the central controller 110 may receive a grid event trigger from a bulk electricity market coordinator, service person, or from the grid operating entity to reduce consumption for maintaining reliable balance between generation and supply. In response to receiving the grid event trigger, the forecasting module 115 prepares a forecast of uncontrolled load over the near term and the command module 114 generates the demand response signal 111 and provides the demand response signal 111 to some or all of the controllable service locations 160_1 and 160_N. In the case of an unplanned grid event, the central controller 110 provides as much notice as practical before the grid event begins. For example, the demand response signal 111 may specify a grid event start time that is 2 to 4 hours in the future.

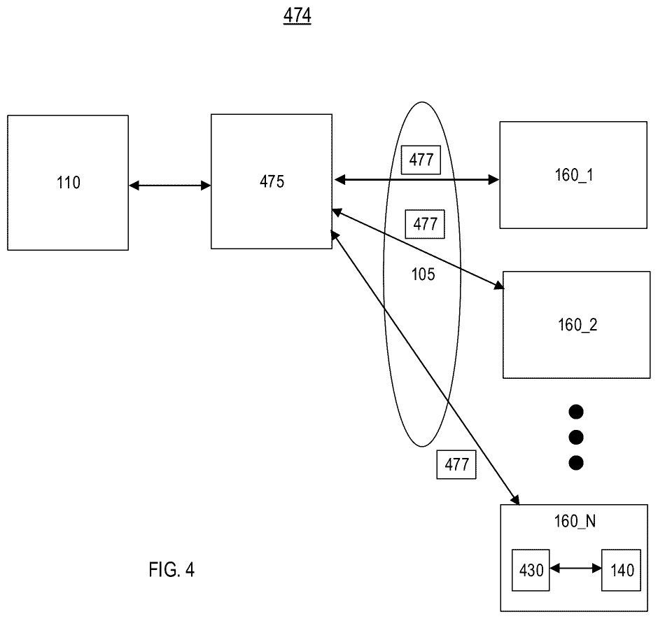

FIG. 4 is an example of an end-to-end (E2E) communication architecture 474 that allows information to be shared between the central controller 110 and the PEMS 140 in each controllable service location 160_1 to 160_N. The E2E communication architecture 474 may be used in the energy management system 100 (FIG. 1A). The central controller 110 is at the head of the E2E communication architecture 474. The E2E architecture 474 uses the existing advanced metering infrastructure (AMI) and the central controller 110 communicates with a headend 475. The headend 475 may be a demand response management system (DRMS), an advanced distribution management system (ADMS), or a DER management system (DERMS). The headend 475 may implement the YUCON software system available from the Eaton Corporation of Cleveland, Ohio. The central controller 110 communicates with the headend 475 using representational state transfer (REST) APIs.

Each controllable service location 160_1 to 160_N includes a local controller 430 and a PEMS 140. For simplicity, only the service location 160_N shows the local controller 430 and the PEMS 140 in FIG. 4. The local controller 430 is configured as a client of the headend 475. For example, if the headend 475 is a DRMS, the local controller 430 is a DRMS client. The local controller 430 communicates with the PEMS 140 using TCP/IP. As noted above, the central controller 110 is at the head of the architecture 474. The PEMS 140 is at the other end of the architecture 474. The configuration of the architecture 474 allows a hyper-text transfer protocol (HTTP) to be used at both ends to ensure data security.

The headend 475 transmits information via messages 477 to the local controllers 430 at the controllable service locations 160_1 to 160_N. The local controller 430 shares the information in the messages 477 with the PEMS 140. The PEMS 140 also communicates with the headend 475 via messages that are sent to the headend 475 through the local controller 430. The architecture 474 supports, unicast, multicast, and broadcast messaging. Unicast messaging is a bi-directional point-to-point communication in which the central controller 110 sends one or more messages 477 to a specified local controller 430 with a unique user identifier. The local controller 430 also sends one or more messages 477 back to the central controller 110. For example, when the local controller 430 initially becomes available online, the local controller 430 sends a discovery message to the central controller 110 to notify the central controller 110 of its availability. After the discovery message is received, the central controller 110 may send an acknowledgment message to the local controller 430.

Multicast messaging is a unidirectional approach in which the central controller 110 sends the same message to a group of local controllers 430 specified with a group identifier. An example of such a message is location-specific weather information that the central controller 110 sends to the group of local controllers 430. Each local controller 430 then provides the weather information to its respective PEMS 140.

Broadcast messaging is a unidirectional message sending approach in which the central controller 110 sends the same message 477 to all the local controllers 430 that are in the network or connected to the same node in the network. For example, the central controller 110 may send the demand response signal 111 as a broadcast message to the local controller 430 in all of the controlled service locations 160_1 to 160_N.

The messages 477 may be in JavaScript Object Notation (JSON). The messages 477 include a header and content. The header may include, for example, the message type and identifying information, such as an identifier of the local controller 430 that is to receive the message 447, or a group identifier of a group of local controllers 430 that are to receive the message. The content is the information to be conveyed by the message 477. Tables 1 and 2 below provide examples of content that may be included in the messages 477.

The messages 477 may be exchanged at fixed intervals (for example, every 2, 4, 6 hours or every day), in response to an occurrence, randomly, or on an as-needed basis. In some implementations, a priority is assigned to each message 477. In these implementations, high priority messages are transferred immediately once the messages enter the network 105, and transmission of low priority messages is delayed until the network 105 is not processing high priority messages. Furthermore, the delay of the low priority messages may be randomized. Furthermore, the PEMS 140 controls the BTM controllable energy resources 150 (for example, IEEE 2030.5-enabled devices). An HTTP server may be wrapped on top of the IEEE 2030.5 server, and the PEMS 140 communicates with the HTTP server by getting and posting data. The data is transferred to the IEEE 2030.5 server, through which the information is sent to the gateway of the controllable energy resource (for example, an inverter) to control and/or query the status of the resource.

Table 1 shows examples of messages 477 that the PEMS 140 sends to the central controller 110. The PEMS 140 generates the message 477, transmits the message to the local controller 430 via TCPIP, the local controller 430 transmits the message 477 via the network 105 to the headend 475, and the headend 475 communicates the message 477 to the central server 110 via REST APIs.

TABLE 1

| Index | Variable | Units | Priority | Relates To | Frequency/Timing |
|---|---|---|---|---|---|
| 1 | Discovery message | none | High | Status of PEMS | Only when PEMS |
| | | | | | 140 comes online |
| 2 | DER flexibility | kW | High | Margin of energy | Only during grid |
| | bound | | | available at the | event |
| | | | | controllable service | |
| | | | | location | |
| 3 | Net controllable | kW | Low | Portion of load that | Regular interval |
| | load | | | is controllable at the | (for example, every |
| | | | | controllable service | 6 hours) |
| | | | | location | |
| 4 | Net premises load | kW | Low | Total load at the | Regular interval |
| | | | | controllable service | (for example, every |
| | | | | location | 6 hours) |
| 5 | DER nameplate | kW, %, | High | Nameplate | Once |
| | information | kW | | information for | |
| | (Capacity, | | | DERs at the | |
| | efficiency, and | | | controllable service | |
| | inverter power) | | | location | |
| 6 | Premises thermal | ° C./kW | High | Thermal | Only during grid |
| | parameters (Thermal | and | | characteristics of the | event |
| | resistance, and | kJ/° C. | | controllable service | |
| | thermal capacitance) | | | location | |
| 7 | Premises DER states | %, ° C., % | High | State of various | Only during grid |
| | (Battery state of | | | DERs at the | event |
| | charge (SoC), Indoor | | | controllable | |
| | Temperature, EV | | | service | |
| | SoC) | | | location | |
| 8 | Predicted weather | varies | High | Premises request for | As needed |
| | data request | | | weather data | |
| 9 | Nodal Control | varies | High | PEMS 140 identifier | As needed |
| | Group Update | | | | (whenever |
| | (PEMS 140 | | | | updated) |
| | identifier, PEMS 140 | | | | |
| | assigned Group ID) | | | | |
| 10 | Premises-level | kW | High | Highest amount of | Only during grid |
| | power threshold | | | electrical energy the | event |
| | commitment | | | controllable service | |
| | | | | location is expected | |
| | | | | to consume | |
| 11 | Premises-level status | varies | Low | BTM energy | Regular intervals |
| | | | | resources 150 | or upon request of |
| | | | | availability | central controller |
| | | | | | 110 |

Table 2 shows examples of messages 477 that the central controller 110 sends to the PEMS 140. The central controller 110 communicates the message 477 to the headend 475, the headend 475 communicates the message 477 to one or more local controllers 430 via the network 105, and the local controller 430 provides the message 477 to the PEMS 140.

TABLE 2

| Variable | Units | Priority | Relates To | Frequency/Timing |
|---|---|---|---|---|
| Nodal control group | NA | High | Identifiers | Whenever the central |
| update (local controller | | | | controller 110 |
| 430 identifier, or group | | | | updates the |
| assignment) | | | | identifiers |
| Nodal price | Cost | High | Increased cost of | Only during grid |
| | per | | energy during grid | event |
| | kwh | | event | |
| Electricity Tariff | Cost | High | Actual cost of energy | During grid event |
| | per | | | and idle mode |
| | kwh | | | |
| Measured weather data | varies | Low | Weather data measured | Regular interval (for |
| | | | or received by central | example, every 2 |
| | | | controller 110 | hours to every 6 |
| | | | | hours) |
| Predicted weather data | varies | Low | Predicted weather | Regular interval (for |
| | | | information | example, every 6 |
| | | | | hours) |
| Demand response | varies | High | Demand response | Prior to grid event |
| signal 111 | | | signal 111 | |
| Request for premises | varies | Low | Information request | As needed |
| stats | | | | |

Table 2 includes examples of messages 477 that the central controller 110 may send to the PEMS 140 in one or more of the controllable service locations 160_1 to 160_N. Other messages are possible. For example, the central controller 110 may send acknowledgement messages to the PEMS 140 in response to receiving any of the messages 477 shown in Table 1.

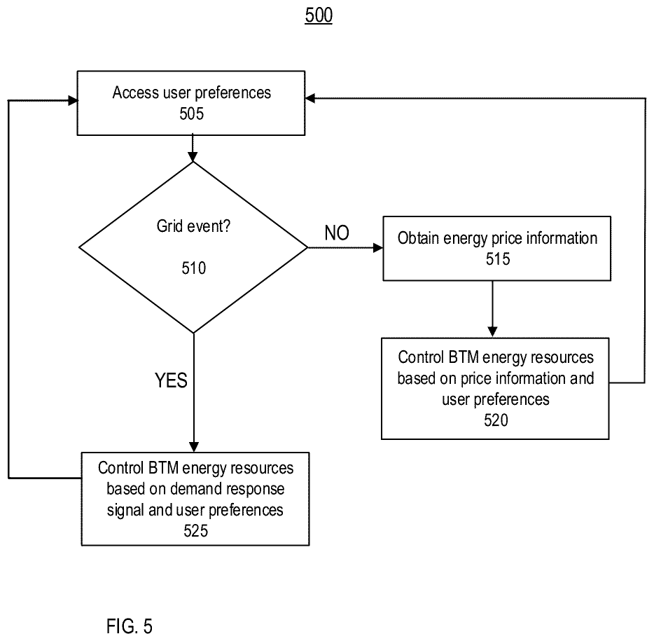

FIG. 5 is a flow chart of a process 500. The process 500 is an example of a process for managing behind-the-meter energy resources. The process 500 may be performed by the electronic processing module 148 in the PEMS 140. The process 500 is discussed with respect to FIG. 2 to provide an example. In the example below, the BTM energy resources 150 coupled to the PEMS 140 include a battery and an HVAC system. For the example discussed below, the operating preferences 143 specify that the HVAC maintain a room temperature of 70° F. to 75° F. and that the battery have at least a 50% charge.

The operating preferences 143 are accessed (505). The operating preferences 143 are stored on the electronic storage 144. The PEMS 140 determines whether a demand response signal 111 is present or if a grid event is in progress (510). If no demand response signal 111 is present, there is no grid event in progress. The PEMS 140 operates in the idle mode and seeks to reduce energy costs at the controlled service location 160_1 without accounting for a demand response signal 111.

The PEMS 140 obtains the pricing information 182 (515). The pricing information 182 may be obtained from the central controller 110. For example, the PEMS 140 may request the pricing information 182 from the central controller 110, which may provide the pricing information 182 to the PEMS 140 as a message 477. In another example, the PEMS 140 may obtain the pricing information 182 from an energy marketplace server. The PEMS 140 also may obtain the climate information 181.

The PEMS 140 controls the BTM energy resources based on the price information and the operating preferences (520). The scheduling module 146 determines the operating plan using information about the BTM energy resources 150 and the pricing information. For example, if the pricing information 182 indicates that the price of energy is highest between 6 μm and 7 μm, and the climate information 181 indicates that the outside temperature is above 75° F. for the entire day, the scheduling module 146 of the PEMS 140 determines an operating plan that specifies that the HVAC is to pre-cool the internal temperature to near 70° F. during low energy price before 6 μm to minimize HVAC operations from 6 μm to 7 μm and maintain the internal temperature near to 75° F. at other times of the day to save electricity costs. Furthermore, the operating plan may specify that the battery is to be charged to 100% during low energy price before 6 μm to ensure it has enough energy capacity to discharge energy for appliances in location 160 when the price of energy is highest between 6 μm and 7 μm. The operating plan may also specify the battery to be charged or discharged at other times that minimizes the total electricity cost for location 160.

The command module 147 communicates the operating plan to the HVAC over the control link 142. This operating plan allows the HVAC to cool the premises most aggressively when the price of energy is the lowest, thus reducing overall costs for the customer while also operating the HVAC in accordance with the operating preferences 143.

The process 500 returns to (505) to again access the operating preferences 143 and continues to operate in the idle mode until a demand response signal 111 is received. When a demand response signal 111 is received, the PEMS 140 operates in the grid event mode. The PEMS 140 determines the operating plan for the BTM energy resources (the HVAC in this example) based on the demand response signal 111 and the operating preferences 143 (525). To provide an example, the demand response signal 111 indicates that a grid event is going to occur in 6 hours, will last 3 hours, and will require a 20% reduction in energy consumption during the grid event. The scheduling module 146 determines the operating plan based on the demand response signal 111 and the operating preferences 143. For example, the scheduling module 146 may determine that the HVAC should be operated so that the room temperature is pre-cooled to 70° F. at the beginning of the grid event, and that the HVAC will be operated for no more than 2 hours of the grid event and only to the extent needed to maintain the room temperature at 75° F. during the grid event.

After the grid event ends, the process 500 returns to (505).

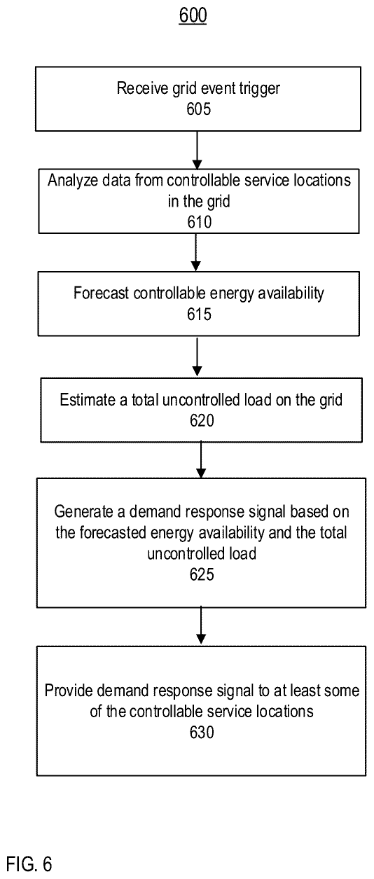

FIG. 6 is a flow chart of a process 600. The process 600 is an example of a process for managing energy on the power grid 190. The process 600 is performed by the central controller 110.

A grid event trigger is received (605). The grid event trigger is any type of signal or input that indicates that a grid event will occur. The grid event trigger may be input into the central controller 110 manually by the grid operating entity, received from an external device (such as a remote computer), or may be issued based on a pre-determined schedule. For example, the grid event trigger may be received from a grid monitoring apparatus in response to detecting a power imbalance. In another example, the grid operating entity inputs a grid event trigger in view of planned maintenance. The grid event trigger may specify the time in the future when the grid event will occur and the duration of the grid event.

The central controller 110 analyzes the data 165 from the controllable service locations 160_1 to 160_N (610). The analysis may be performed by the data aggregation module 116. The analysis includes aggregating the data 165 from all of the controllable service locations 160_1 to 160_N. Examples of the content of the data 165 is shown in Table 1. The aggregated data may include, for example, the total premises load, the total controllable load, and the total uncontrollable load across all of the controllable service locations 160_1 to 160_N.

The controllable energy availability during the grid event is forecasted (615). The forecasting module 115 estimates the amount of controllable energy that will be available during the grid event based on the aggregated data. For example, the total controllable load may be the sum of the controllable load at each of the controllable service locations. In some implementations, the amount of controllable energy that will be available also considers the weather information 171, and the grid information 195. For example, if the weather information 171 indicates that severe weather is present or expected in a portion of the grid 190 that includes some of the controllable service locations, the controllable energy at those locations is subtracted from the total controllable energy that is expected to be available. In another example, if the grid information 195 indicates that a feeder to one of the controllable service locations is malfunctioning, the controllable energy that would be available at that service location is subtracted from the total controllable energy that is expected to be available.

The uncontrolled load during the grid event is estimated (620). The uncontrolled load includes the uncontrolled loads 164 at the controllable service locations 160_1 to 160_N and the load of the uncontrolled service locations 162_1 to 162_N. Information about the uncontrolled loads 164 is included in the data 165 from the controllable service locations 160_1 to 160_N. Information about the uncontrolled service locations 162_1 to 162_N may be represented by historical load profiles that are stored on the electronic storage 112 of the central controller 110.

The demand response signal 111 is generated (630). The demand response signal 111 includes a time at which the grid event is to begin, a duration of the grid event, and a grid event threshold. The grid event threshold specifies an energy consumption limit or an energy reduction compared to a nominal amount for the duration of the grid event. The start time and duration of the grid event depend on the circumstance and may be specified by the grid operating entity. The grid event threshold is determined by the central controller 110. For example, the grid event threshold may be determined by computing an energy margin, which is a difference between the total controllable energy and the total uncontrolled load. The energy margin divided by N is the amount of energy that each controllable service location 160_1 to 160_N is allocated to use during the grid event.

The demand response signal 111 is provided to the local controller 130 or 430 in some or all of the controllable service locations 160_1 to 160_N (630). The local controller provides the demand response signal 111 to the PEMS 140. The PEMS 140 controls the BTM energy resources 150 in a manner that reduces the energy consumption as specified in the grid event threshold and also complies with the operating preferences 143.

These and other implementations are within the scope of the claims.

What is claimed is:

1. A system comprising:
a central controller configured to generate an energy management request; and
one or more client controllers, wherein each of the one or more client controllers is configured to communicate with the central controller through a first communications network, each of the one or more client controllers is associated with a controllable service location, and each of the one or more client controllers is configured to communicate with a premises energy management system (PEMS) that commands one or more controllable energy resources at the controllable service location to operate according to a user specification and the energy management request.

2. The system of claim 1, wherein the central controller generates the energy management request based on information from the PEMS.

3. The system of claim 2, wherein the information comprises one or more of a forecasted energy consumption of the one or more controllable energy resources, a forecasted energy production of the one or more controllable energy resources, a net controllable load at the controllable service location, thermal characteristics of the controllable service location, and a net load at the controllable service location.

4. The system of claim 1, wherein the central controller generates the energy management request based on forecasted whether information.

5. The system of claim 1, wherein the central controller generates the energy management request based on input from a grid operating entity.

6. The system of claim 1, wherein the central controller generates the energy management request based on a pre-determined temporal schedule.

7. The system of claim 1, wherein the first communications network comprises a radio-frequency (RF) mesh network, and each client controller communicates with the respective PEMS using a two-way communications protocol.

8. The system of claim 7, wherein the central controller communicates with a headend, and the headend communicates with the first communications network.

9. The system of claim 8, wherein the central controller communicates with the headend via a hypertext transfer protocol (HTTP), and each client controller communicates with the respective PEMS via HTTP.

10. The system of claim 9, wherein the headend comprises a demand response management system (DRMS), an advanced distribution management system (ADMS), or a DER management system (DERMS).

11. The system of claim 1, wherein each client controller communicates with one or more of a metering system, a breaker, and a load sensor.

12. A premises energy management system comprising:
a communications module configured to communicate with a controllable energy resource;
a preference module configured to store a specification that defines one or more acceptable operating bounds for the controllable energy resource; and
a scheduling module configured to determine an operating plan for the controllable energy resource, the scheduling module comprising an idle operating mode and a grid-event operating mode, wherein in the idle operating mode, the scheduling module is configured to determine the operating plan based on price information and the one or more acceptable operating bounds; and, in the grid-event operating mode, the scheduling module is configured to determine the operating plan based on the one or more acceptable operating bounds and a demand request.

13. The premises energy management system of claim 12, further comprising: a command module configured to provide a command signal to the controllable energy resource based on the operating plan.

14. The premises energy management system of claim 12, further comprising a climate module configured to receive climate information, and wherein the scheduling module is configured to determine the operating plan based on the climate information.

15. The premises energy management system of claim 12, wherein the communications interface is configured to communicate with the controllable energy resource using the IEEE 2030.5 protocol, and the communications interface is further configured to communicate with a local controller.

16. The premises energy management system of claim 15, wherein the communications interface is configured to communicate with the local client controller using Transmission Control Protocol/Internet Protocol (TCP/IP) or User Datagram Protocol (UDP).

17. The premises energy management system of claim 12, further comprising an input/output module, and wherein the specification is configured to be edited through the input/output module.

18. A method for managing energy usage in a power grid, the method comprising:
receiving information generated by a plurality of premises energy management systems, each premises energy management system (PEMS) being associated with a distinct controlled service location;
receiving a grid event trigger;
determining an energy management request based on the information from the plurality of PEMS; and
managing energy usage in the power grid by providing the energy management request to one or more recipient PEMS, wherein each of the one or more recipient PEMS is associated with one distinct controlled service location.

19. The method of claim 18, further comprising:
accessing information related to one or more distinct uncontrolled service locations that are not associated with a premises energy management system; and wherein the energy management request is based on the information related to the one or more distinct uncontrolled service locations and the information from the plurality of PEMS.

20. The method of claim 18, wherein the information from the plurality of PEMS comprises one or more of a controllable energy resource consumption range, a net controllable load, a net load, distributed energy resource (DER) nameplate information, service location thermal parameters, DER state information, and weather information.
